(19) United States
(12) Patent Application Publication
(10) Pub. No.: US 2026/0361616 A1
(43) Pub. Date: Nov. 12, 2026

(54) UPLINK TRANSMISSION CONFIGURATION METHOD AND APPARATUS

(71) Applicant: 1FINITY Inc., Kawasaki-shi (JP)

(72) Inventors: Guotong WANG, Beijing (CN); Xin WANG, Beijing (CN); Gang SUN, Beijing (CN); Qun ZHANG, Beijing (CN); Liqiang JIN, Beijing (CN)

(73) Assignee: 1FINITY Inc., Kawasaki-shi (JP)

(21) Appl. No.: 19/731,617

(22) Filed: Jul. 6, 2026

Related U.S. Application Data
(63) Continuation of application No. PCT/CN2024/072015, filed on Jan. 12, 2024.

(51) Int. Cl. H04L 41/16; H04B 17/318; H04W 52/14

(52) U.S. Cl. CPC H04L 41/16; H04B 17/328; H04W 52/146

(57) ABSTRACT

An uplink transmission configuration apparatus includes: a receiver configured to receive configuration information from a network device, the configuration information being used to configure an AI/ML functionality/model and/or uplink power control; and processor circuitry configured to obtain uplink power control information for uplink transmission according to the configuration information.

### CROSS-REFERENCE TO RELATED APPLICATION

This application is a continuation application under 35 U.S.C. 111(a) of International Patent PCT/CN2024/072015 filed on Jan. 12, 2024, and designated the U.S., the entire contents of which are incorporated herein by reference.

### TECHNICAL FIELD

Embodiments of the present disclosure relate to the field of communication technologies.

### BACKGROUND

In NR Rel-18, artificial intelligence/machine learning (AI/ML) for an air interface is studied. The AI/ML may be available for the following use cases: channel state information (CSI) feedback enhancement, beam management, and positioning enhancement. The CSI feedback enhancement may include CSI prediction and CSI compression; the beam management may include a spatial beam prediction and a temporal beam prediction; and the positioning enhancement may include direct positioning and AI/ML-assisted positioning.

In some sub-use cases, a bilateral model may be used, that is, an AI/ML model is at a terminal equipment side and at a network device side. In other sub-use cases, a unilateral model may be used, that is, an AI/ML model is at a terminal equipment side or at a network device side. For beam management, the AI/ML model may be at the terminal equipment side and/or at the network device side.

It should be noted that the above introduction to the background is merely provided for clear and complete explanation of technical solutions of the present disclosure and for easy understanding by those skilled in the art. And it should not be understood that these technical solutions are known to those skilled in the art only because they are described in the background of the present disclosure.

### SUMMARY

The inventors found that a terminal equipment and/or a network device is/are able to use AI/ML functionality/model to predict a beam according to a beam measurement result. However, there is currently no definite solution on how to consider uplink power control.

In view of at least one of the above problems, embodiments of the present disclosure provide a n uplink transmission configuration method and apparatus.

According to one aspect of the embodiments of the present disclosure, there is provided an uplink transmission configuration method, including:
receiving, by a terminal equipment, configuration information from a network device, the configuration information being used to configure an AI/ML functionality/model and/or uplink power control; and
obtaining, by the terminal equipment, uplink power control information for uplink transmission according to the configuration information.

According to another aspect of the embodiments of the present disclosure, there is provided an uplink transmission configuration apparatus, including:
a receiving unit configured to receive configuration information from a network device, the configuration information being used to configure an AI/ML functionality/model and/or uplink power control; and
a processing unit configured to obtain uplink power control information for uplink transmission according to the configuration information.

According to another aspect of the embodiments of the present disclosure, there is provided an uplink transmission configuration method, including:
transmitting, by a network device, to a terminal equipment, configuration information, the configuration information being used to configure an AI/ML functionality/model and/or uplink power control, the configuration information being used by the terminal equipment to obtain uplink power control information for uplink transmission.

According to another aspect of the embodiments of the present disclosure, there is provided an uplink transmission configuration apparatus, including:
a transmitting unit configured to transmit, to a terminal equipment, configuration information, the configuration information being used to configure an AI/ML functionality/model and/or uplink power control, the configuration information being used by the terminal equipment to obtain uplink power control information for uplink transmission.

According to another aspect of the embodiments of the present disclosure, there is provided a communication system, including:
a network device configured to transmit, to a terminal equipment, configuration information the configuration information being used to configure an AI/ML functionality/model and/or uplink power control; and
a terminal equipment configured to obtain uplink power control information for uplink transmission according to the configuration information.

One of advantageous effects of the embodiments of the present disclosure is that a terminal equipment receives configuration information from a network device, the configuration information being used to configure an AI/ML functionality/model and/or uplink power control, thus uplink power control information including a pathloss is able to be more accurately obtained, and therefore, accuracy and reliability of the uplink transmission are improved.

With reference to the following description and drawings, particular embodiments of the present disclosure are disclosed in detail, and the manners in which the principle of the present disclosure may be used are indicated. It should be understood that the scope of the embodiments of the present disclosure is not limited thereto. The embodiments of the present disclosure contain a plurality of alternations, amendments and equivalents within the spirit and the scope of the terms of the appended claims.

Features that are described and/or illustrated with respect to one embodiment may be used in a same way or in a similar way in one or more other embodiments, in combination with or instead of the features of the other embodiments.

It should be emphasized that the term “comprise/include” when used herein refers to the presence of features, integers, steps or components, but does not preclude the presence or addition of one or more other features, integers, steps or components.

### BRIEF DESCRIPTION OF THE DRAWINGS

Elements and features depicted in one drawing or embodiment of the present disclosure may be combined with elements and features depicted in one or more additional drawings or embodiments. Moreover, in the drawings, similar reference numerals designate corresponding parts throughout multiple drawings and may be used to designate like or similar parts in more than one embodiment.

FIG. 1 is a schematic diagram illustrating a communication system according to embodiments of the present disclosure;

FIG. 2 is a schematic diagram illustrating an uplink transmission configuration method according to embodiments of the present disclosure;

FIG. 3 is another schematic diagram illustrating the uplink transmission method according to embodiments of the present disclosure;

FIG. 4 is another schematic diagram illustrating the uplink transmission configuration method according to embodiments of the present disclosure;

FIG. 5 is a schematic diagram illustrating an uplink transmission configuration apparatus according to embodiments of the present disclosure;

FIG. 6 is another schematic diagram illustrating the uplink transmission configuration apparatus according to embodiments of the present disclosure;

FIG. 7 is a schematic diagram illustrating a terminal equipment according to embodiments of the present disclosure; and

FIG. 8 is a schematic diagram illustrating a network device according to embodiments of the present disclosure.

### DETAILED DESCRIPTION

The above and other features of the present disclosure will be apparent with reference to the following description and drawings. In the description and drawings, particular embodiments of the present disclosure have been disclosed in detail as being indicative of some of the embodiments in which the principles of the present disclosure may be employed, however, it should be understood that the present disclosure is not limited to the embodiments described herein. Rather, the present disclosure includes all amendments, variants and equivalents falling within the scope of the appended claims.

In embodiments of the present disclosure, terms “first”, “second”, etc. are used to differentiate different elements with respect to names, and do not indicate spatial arrangement or temporal orders of these elements, and these elements should not be limited by these terms. Terms “and/or” include any one and all combinations of one or more relevantly listed terms. Terms “comprising”, “including”, “having” refer to presence of stated features, elements, components, or assemblies, but do not exclude presence or addition of one or more other features, elements, components, or assemblies.

In embodiments of the present disclosure, singular forms “a”, “the”, etc., include plural forms, and should be understood as “a kind of” or “a type of” in a broad sense, but should not be limited to a meaning of “one”; and the term “the” should be understood as including both a singular form and a plural form, except clearly specified otherwise. Furthermore, the term “according to” should be understood as “at least partially according to . . . ”, the term “based on” should be understood as “at least partially based on . . . ”, except clearly specified otherwise.

In embodiments of the present disclosure, the term “communication network” or “wireless communication network” may refer to a network satisfying any one of communication standards, such as Long Term Evolution (LTE), Long Term Evolution-Advanced (LTE-A), Wideband Code Division Multiple Access (WCDMA), and High-Speed Packet Access (HSPA), etc.

Furthermore, communication between devices in a communication system may be performed according to communication protocols at any stage, which may, for example, include but not limited to the communication protocols: 1G (generation), 2G, 2.5G, 2.75G, 3G, 4G, 4.5G, and 5G, New Radio (NR) and 6G in the future, etc., and/or other communication protocols that are currently known or will be developed in the future.

In embodiments of the present disclosure, the term “network device”, for example, refers to a device in a communication system that accesses a terminal equipment to a communication network and provides services for the terminal equipment. The network device may include but not limited to devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), an IAB host, etc. Furthermore, the base station may include a remote radio head (RRH), a remote radio unit (RRU), a relay, or a low-power node (such as a femto, and a pico, etc.). And the term “base station” may include some or all of its functions, and each base station may provide communication coverage for a specific geographic area. And a term “cell” may refer to a base station and/or its coverage area, depending on a context in which the term is used.

In embodiments of the present disclosure, the term “user equipment” (UE) or “terminal equipment or terminal device” (TE) refers to, for example, an equipment accessing to a communication network and receiving network services via a network device. The terminal equipment may be fixed or mobile, and may also be referred to as a mobile station (MS), a terminal, a subscriber station (SS), an access terminal (AT), a station, etc.

The terminal equipment may include but not limited to devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, the terminal equipment may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or include one or more network devices described above. The term “user side” or “terminal side” or “terminal equipment side” refers to a side of a user or a terminal, which may be a UE, or may include one or more terminal equipments described above. “A device” in this text may refer to a network device, and may also refer to a terminal equipment, except otherwise specified.

Scenarios of embodiments in the present disclosure shall be described below by way of examples. However, the present disclosure is not limited thereto.

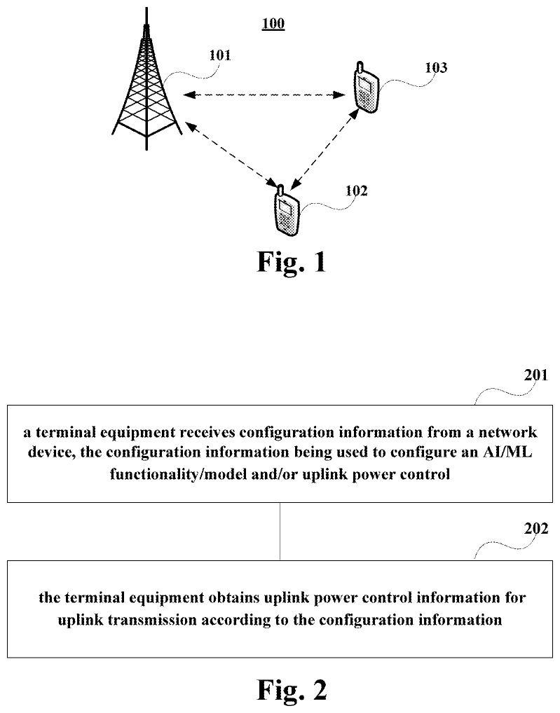

FIG. 1 is a schematic diagram illustrating a communication system according to embodiments of the present disclosure, which schematically illustrates a situation in which a terminal equipment and a network device are used as an example. As illustrated in the FIG. 1, a communication system 100 may include a network device 101 and terminal equipments 102 and 103. For the sake of simplicity, the FIG. 1 only illustrates two terminal equipments and one network device as an example, however, the embodiments of the present disclosure are not limited thereto.

In embodiments of the present disclosure, existing services or services that may be implemented in the future may be transmitted between the network device 101 and the terminal equipments 102 and 103. For example, these services may include but are not limited to: an enhanced Mobile Broadband (eMBB), a massive Machine Type Communication (mMTC), and an Ultra-Reliable and Low Latency Communication (URLLC), etc.

It should be noted that the FIG. 1 illustrates that both the terminal equipments 102 and 103 within coverage of the network device 101, however, the present disclosure is not limited thereto. Both the terminal equipments 102 and 103 may not fall within the coverage of the network device 101, or one terminal equipment 102 falls within the coverage of the network device 101 and the other terminal equipment 103 falls out of the coverage of the network device 101.

In embodiments of the present disclosure, higher layer signaling may be, for example, radio resource control (RRC) signaling; for example, an RRC message, including, for example, a MIB, system information, a dedicated RRC message; or an RRC IE (RRC information element). The higher layer signaling may also be, for example, MAC (Medium Access Control) signaling; or a MAC CE (MAC control element). However, the present disclosure is not limited thereto.

For uplink transmission including a physical uplink shared channel (PUSCH), a physical uplink control channel (PUCCH) and a sounding reference signal (SRS), uplink power control may be performed. For example, a network device may configure a pathloss reference signal for a terminal equipment, and the terminal equipment may measure reference signal received power (RSRP) of the pathloss reference signal and further calculate or estimate a pathloss.

With the introduction of AI/ML, a terminal equipment and/or a network device is/are able to use an AI/ML functionality/model, e.g., predict a beam according to a beam measurement result. However, in these scenarios, there is currently no definite solution on how to consider uplink power control.

For example, a first reference signal resource set (set A) for beam prediction in AI/ML for beam management may not be transmitted due to reduced overhead. In this case, how to configure a pathloss reference signal and how to estimate a pathloss of uplink transmission are currently unclear.

In embodiments of the present disclosure, one or more AI/ML models may be configured and run in a network device and/or a terminal equipment. The AI/ML model may be used for various signal processing functions of wireless communications, such as CSI prediction, CSI compression, beam prediction, positioning management, etc. The present disclosure is not limited thereto.

### Embodiments of a First Aspect

Embodiments of the present disclosure provide an uplink transmission configuration method described from a terminal equipment side.

FIG. 2 is a schematic diagram illustrating an uplink transmission configuration method according to embodiments of the present disclosure. As illustrated in the FIG. 2, the method includes:
201: a terminal equipment receives configuration information from a network device, the configuration information being used to configure an AI/ML functionality/model and/or uplink power control; and
202: the terminal equipment obtains uplink power control information for uplink transmission according to the configuration information.

It should be noted that the FIG. 2 only schematically illustrates the embodiments of the present disclosure, however, the present disclosure is not limited thereto. For example, an order of execution of operations may be appropriately adjusted, and some other operations may be added, or some operations therein may be removed. And appropriate variants may be made by those skilled in the art according to the above content, without being limited to the disclosure illustrated in the FIG. 2.

In some embodiments, functionality refers to an AI/ML feature/feature group enabled by a configuration, in which the configuration is supported based on conditions indicated by UE capabilities.

For example, AL/ML functionality may be one or more functionalities, or may be one or more logical models, or may be one or more sub-functionalities, or may be one or more features, or may be one or more feature groups.

For another example, functionality may refer to using AI/ML for a spatial beam prediction, or using AI/ML for a temporal beam prediction, or using AI/ML for CSI prediction, or using AI/ML for direct positioning, or using AI/ML for assisted positioning, etc.

In some embodiments, configuration information may configure beam management, and may include configuration information of one or more reference signals for beam management or beam measurement, such as CSI-RS configuration information, etc. And/or configuration information may configure uplink power control, for example, including configuration information of one or more pathloss reference signals for uplink power control. The present disclosure is not limited thereto. Reference may be made to the related arts for specific configuration information.

In some embodiments, the terminal equipment estimates or predicts the uplink power control information based on an AI/ML functionality/model. For example, the uplink power control information includes a pathloss, however, the present disclosure is not limited thereto, and other information may also be involved.

In some embodiments, the AI/ML functionality/model is used to predict reference signal received power (RSRP) of a pathloss reference signal to estimate a pathloss corresponding to the pathloss reference signal. The present disclosure is not limited thereto. Uplink power control information may also be obtained by non-AI/ML.

For example, one or more reference signals are used for measurement and a measurement result (measured RSRP) is input into the AI/ML functionality/model, and another one or more reference signals are used for output of the AI/ML functionality/model for inference. Reference may be made to the related arts for specific content of the AI/ML functionality/model and specific concepts such as inference.

In some embodiments, the AI/ML functionality/model is used to estimate or predict a pathloss of certain beams in a spatial domain.

For example, an input of the AI/ML functionality/model is RSRP measured to one or more reference signals, the AI/ML functionality/model outputs RSRP of certain beams for a spatial prediction, and another one or more reference signals are used at an output of the AI/ML functionality/model for inference.

In some embodiments, the AI/ML functionality/model is used to estimate or predict a pathloss of certain beams in a temporal domain.

For example, an input of the AI/ML functionality/model is RSRP measured to one or more reference signals, the AI/ML functionality/model outputs RSRP of certain beams for a plurality of time instances prediction, and another one or more reference signals are used at an output of the AI/ML functionality/model for inference.

In some embodiments, an AI/ML functionality/model for uplink power control is the same as an AI/ML functionality/model for beam management. In other embodiments, an AI/ML functionality/model for uplink power control is different from an AI/ML functionality/model for beam management.

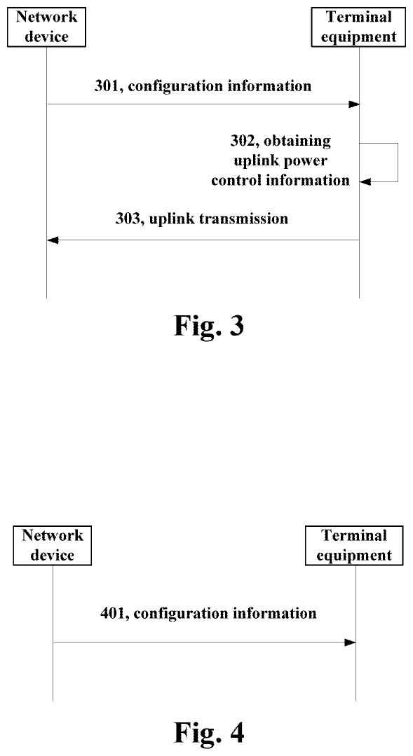

FIG. 3 is another schematic diagram illustrating the uplink transmission method according to embodiments of the present disclosure described by taking a terminal equipment configured with AIML as an example. As illustrated in the FIG. 3, the method includes:
301: a terminal equipment receives configuration information from a network device;
for example, the configuration information includes a configuration for uplink power control, such as a configuration of a pathloss reference signal. In addition, the configuration information may also be used for beam management, for example, the configuration information may also include a second reference signal resource set (set B) for beam measurement and/or a first reference signal resource set (set A) for beam prediction;
302: the terminal equipment obtains uplink power control information;
for example, the terminal equipment may receive a pathloss reference signal from a network device and estimate or predict RSRP using AI/ML to obtain a pathloss. In addition, the terminal equipment may also perform beam measurement and input a beam measurement result into an AI/ML functionality/model; for example, the measurement result of the reference signals in the set B is used as an input of AI/ML, and the reference signals in the set A is used for prediction (or inference); and
303: the terminal equipment transmits an uplink transmission to the network device.

For example, an AI/ML functionality is located at a terminal equipment side. After the AI/ML functionality is enabled or activated, the terminal equipment measures a pathloss reference signal from a network side, performs a prediction using AI/ML according to a measurement result to obtain uplink power control information (such as pathloss), and transmits, to a network device, an uplink transmission according to the pathloss.

For another example, an AI/ML functionality is located at a terminal equipment side. After the AI/ML functionality is enabled or activated, the terminal equipment performs beam measurement according to a reference signal from a network side, performs a beam prediction using AI/ML according to a beam measurement result, and transmits a prediction result to a network device.

It should be noted that the FIG. 3 only schematically illustrates the embodiments of the present disclosure, however, the present disclosure is not limited thereto. For example, an order of execution of operations may be appropriately adjusted, and some other operations may be added, or some operations therein may be removed. And appropriate variants may be made by those skilled in the art according to the above content, without being limited to the disclosure illustrated in the FIG. 3.

Cases of beam management based on AI/ML are schematically illustrated above. The process of uplink power control may be combined with the beam management process in the FIG. 3, or may be performed separately similar to the FIG. 3. Input and output of an AI/ML functionality/model for uplink power control will be schematically illustrated below.

In some embodiments, a configured pathloss reference signal is used for input of the AI/ML functionality/model for uplink power control, and predicted RSRP or an estimated pathloss for a current beam is used for output of the AI/ML functionality/model for uplink power control.

For example, a pathloss reference signal may be configured for uplink power control, and the configured pathloss reference signal is used for input of the AI/ML functionality/model for uplink power control. In addition, a reference signal may be selected from a set A for beam management (inference of AI/ML for beam management) as a current beam, and predicted RSRP or an estimated pathloss for the current beam is used for output of the AI/ML functionality/model for uplink power control.

In some embodiments, a reference signal in a second reference signal set (set B) for beam management is used for input of the AI/ML functionality/model for uplink power control, and predicted RSRP or an estimated pathloss for a configured pathloss reference signal is used for output of the AI/ML functionality/model for uplink power control.

For example, a pathloss reference signal may be configured for uplink power control, and the configured pathloss reference signal (predicted RSRP or an estimated pathloss) is used for output (inference or prediction) of the AI/ML functionality/model for uplink power control. In addition, a reference signal may be selected from a set B for beam management (input of AI/ML for beam management), and the reference signal is used for input of the AI/ML functionality/model for uplink power control.

In some embodiments, a reference signal in a second reference signal set (set B) for beam management is used for input of the AI/ML functionality/model for uplink power control, and a reference signal in a first reference signal set (set A) for beam management is used for output of the AI/ML functionality/model for uplink power control.

In some embodiments, predicted RSRP of a reference signal selected from the first reference signal set (set A) is used to estimate a pathloss.

For example, a reference signal may be selected from a set B for beam management (input of AI/ML for beam management), and is used for input of the AI/ML functionality/model for uplink power control. In addition, a reference signal may be selected from a set A for beam management (inference of AI/ML for beam management) as a current beam, for which the predicted RSRP or an estimated pathloss is used for output of the AI/ML functionality/model for uplink power control.

For another example, an AI/ML functionality/model for beam management is reused for uplink power control, that is, an AI/ML functionality/model for beam management is also used for RSRP prediction and pathloss estimation for uplink power control.

The AI/ML functionality/model for uplink power control is schematically illustrated above, and the pathloss reference signal for uplink power control will be further described below. In the following description, uplink power control may be based on AI/ML or non-AI/ML (e.g., using a legacy solution); for example, an AI/ML functionality/model for uplink power control may be configured or enabled, or not configured or enabled.

In some embodiments, an AI/ML functionality/model for beam management is configured or enabled; and one or more reference signals in a second reference signal set (set B) for beam management are configured as pathloss reference signals for uplink power control.

For example, some reference signals may be selected from a set B and used as pathloss reference signals.

In some embodiments, an AI/ML functionality/model for beam management is configured or enabled; and one or more reference signals in a first reference signal set (set A) for beam management are configured as pathloss reference signals for uplink power control.

For example, some reference signals may be selected from a set A and used as pathloss reference signals.

In some embodiments, an AI/ML functionality/model for beam management is configured or enabled; and one or more reference signals in a reference signal set for performance monitoring are configured as pathloss reference signals for uplink power control.

For example, the reference signal set for performance monitoring is the same as a first reference signal set (set A) for beam management, or the reference signal set for performance monitoring is different from the first reference signal set (set A), or the reference signal set for performance monitoring at least partially overlaps with the first reference signal set (set A), or the reference signal set for performance monitoring is a subset of the first reference signal set (set A). Some reference signals may be selected from the reference signal set and used as pathloss reference signals.

In some embodiments, an AI/ML functionality/model for beam management is configured or enabled; and a reference signal of a current beam is used for performance monitoring and is configured as a pathloss reference signal for uplink power control.

For example, a reference signal of a current beam is used for performance monitoring and as a pathloss reference signal.

In some embodiments, an AI/ML functionality/model for beam management is configured or enabled; and a demodulation reference signal (DMRS) of a physical downlink control channel (PDCCH) is configured as a pathloss reference signal for uplink power control.

For example, a DMRS of a specific CORESET (such as a CORESET with a lowest ID) is used for a pathloss reference signal. The present disclosure is not limited thereto. The DMRS othf e specific CORESET may also be a DMRS of a predefined CORESET or a DMRS of a configured CORESET.

In some embodiments, an AI/ML functionality/model for beam management is configured or enabled; and a demodulation reference signal (DMRS) of a physical downlink shared channel (PDSCH) is configured as a pathloss reference signal for uplink power control.

In some embodiments, an AI/ML functionality/model for beam management is configured or enabled; and an additional offset is configured for uplink power control to compensate for a pathloss estimation error.

In some embodiments, the additional offset is predefined or configured; and the pathloss estimation error is resulted from an inconsistency between a pathloss reference signal and an uplink beam.

For example, for uplink power control, if an AI/ML operation for beam management has been configured/enabled, an additional offset may be configured for uplink power control. The additional offset may be predefined or configurable. The additional offset may be used to compensate for a pathloss estimation error resulted from a misalignment between a pathloss reference signal and an uplink beam.

As another example, an additional offset may be configured for uplink power control, even if an AI/ML operation for beam management is not enabled.

In embodiments of the present disclosure, uplink power control may include power control of PUSCH, PUCCH or SRS, however, the present disclosure is not limited thereto. In addition, embodiments of the present disclosure may be applied to a terminal equipment side model (UE-side model) and/or a network device side model (gNB-side model). Embodiments of the present disclosure may be applied to a BM case 1 (spatial beam prediction) and/or a BM case 2 (temporal beam prediction).

The above embodiments only illustrate the present disclosure. However, the present disclosure is not limited thereto, and appropriate variants may be made on the basis of the above embodiments. For example, the above embodiments may be used alone, or one or more of the above embodiments may be combined together.

As can be seen from the above embodiments, the terminal equipment receives configuration information from the network device, the configuration information being used to configure an AI/ML functionality/model and/or uplink power control, thus uplink power control information including a pathloss is able to be more accurately obtained, and therefore, accuracy and reliability of the uplink transmission are improved.

### Embodiments of a Second Aspect

Embodiments of the present disclosure provide an uplink transmission configuration method described from a network device side. The embodiments of the second aspect may be combined with the embodiments of the first aspect, and the same contents as those of the embodiments of the first aspect will not be described again.

FIG. 4 is another schematic diagram illustrating the uplink transmission configuration method according to embodiments of the present disclosure. As illustrated in the FIG. 4, the method includes:
401: a network device transmits configuration information to a terminal equipment, the configuration information being used to configure an AI/ML functionality/model and/or uplink power control, and the configuration information being used by the terminal equipment to obtain uplink power control information for uplink transmission.

The above embodiments only illustrate the present disclosure. However, the present disclosure is not limited thereto, and appropriate variants may be made on the basis of the above embodiments. For example, the above embodiments may be used alone, or one or more of the above embodiments may be combined together.

As can be seen from the above embodiments, the terminal equipment receives configuration information from the network device, the configuration information being used to configure an AI/ML functionality/model and/or uplink power control, thus uplink power control information including a pathloss is able to be more accurately obtained, and therefore, accuracy and reliability of the uplink transmission are improved.

### Embodiments of a Third Aspect

Embodiments of the present disclosure provide an uplink transmission configuration apparatus, which may be, for example, a terminal equipment, or may be one or more components or assemblies configured in the terminal equipment, and the same contents as those of the embodiments of the first and second aspects will not be described again.

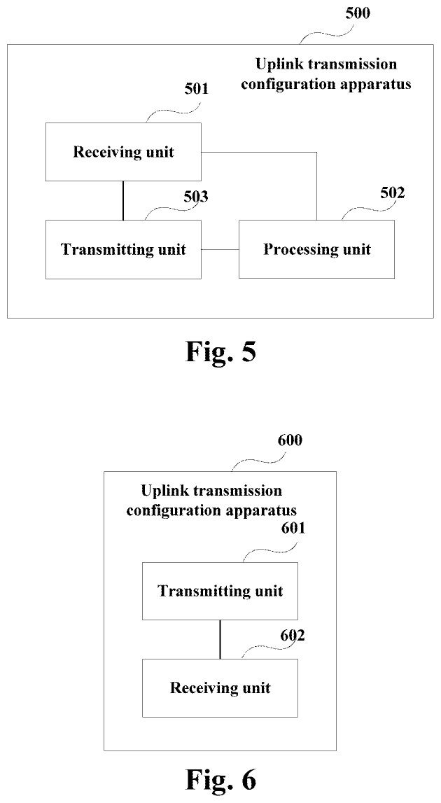

FIG. 5 is a schematic diagram illustrating an uplink transmission configuration apparatus according to embodiments of the present disclosure. As illustrated in the FIG. 5, an uplink transmission configuration apparatus 500 according to embodiments of the present disclosure includes:
a receiving unit 501 configured to receive configuration information from a network device the configuration information being used to configure an AI/ML functionality/model and/or uplink power control; and
a processing unit 502 configured to obtain uplink power control information for uplink transmission according to the configuration information.

In some embodiments, a terminal equipment estimates or predicts the uplink power control information based on an AI/ML functionality/model.

In some embodiments, the uplink power control information includes a pathloss.

The AI/ML functionality/model is used to predict reference signal received power (RSRP) of a pathloss reference signal to estimate a pathloss corresponding to the pathloss reference signal.

In some embodiments, one or more reference signals are used for measurement and measured RSRP is input into the AI/ML functionality/model, and another one or more reference signals are used for output of the AI/ML functionality/model for inference.

In some embodiments, the AI/ML functionality/model is used to estimate or predict a pathloss of one or more beams in a spatial domain, and/or the AI/ML functionality/model is used to estimate or predict a pathloss of one or more beams in a temporal domain.

In some embodiments, an AI/ML functionality/model for uplink power control is the same as an AI/ML functionality/model for beam management, or an AI/ML functionality/model for uplink power control is different from an AI/ML functionality/model for beam management.

In some embodiments, a configured pathloss reference signal is used for input of the AI/ML functionality/model for uplink power control, and predicted RSRP or an estimated pathloss for a current beam is used for output of the AI/ML functionality/model for uplink power control.

In some embodiments, a reference signal in a second reference signal set (set B) for beam management is used for input of the AI/ML functionality/model for uplink power control, and predicted RSRP or an estimated pathloss for a configured pathloss reference signal is used for output of the AI/ML functionality/model for uplink power control.

In some embodiments, a reference signal in a second reference signal set (set B) for beam management is used for input of the AI/ML functionality/model for uplink power control, and a reference signal in a first reference signal set (set A) for beam management is used for output of the AI/ML functionality/model for uplink power control.

In some embodiments, predicted RSRP of a reference signal selected from the first reference signal set (set A) is used to estimate a pathloss.

In some embodiments, an AI/ML functionality/model for beam management is configured or enabled; and one or more reference signals in a second reference signal set (set B) for beam management are configured as pathloss reference signals for uplink power control.

In some embodiments, an AI/ML functionality/model for beam management is configured or enabled; and one or more reference signals in a first reference signal set (set A) for beam management are configured as pathloss reference signals for uplink power control.

In some embodiments, an AI/ML functionality/model for beam management is configured or enabled; and one or more reference signals in a reference signal set for performance monitoring are configured as pathloss reference signals for uplink power control.

In some embodiments, the reference signal set for performance monitoring is the same as a firs reference signal set (set A) for beam management, or the reference signal set for performance monitoring is different from the first reference signal set (set A), or the reference signal set for performance monitoring at least partially overlaps with the first reference signal set (set A), or the reference signal set for performance monitoring is a subset of the first reference signal set (set A).

In some embodiments, an AI/ML functionality/model for beam management is configured or enabled; and a reference signal of a current beam is used for performance monitoring and is configured as a pathloss reference signal for uplink power control.

In some embodiments, an AI/ML functionality/model for beam management is configured or enabled; and a demodulation reference signal (DMRS) of a physical downlink control channel (PDCCH) is configured as a pathloss reference signal for uplink power control.

In some embodiments, an AI/ML functionality/model for beam management is configured or enabled; and a demodulation reference signal (DMRS) of a physical downlink shared channel (PDSCH) is configured as a pathloss reference signal for uplink power control.

In some embodiments, an AI/ML functionality/model for beam management is configured or enabled; and an additional offset is configured for uplink power control to compensate for a pathloss estimation error.

In some embodiments, the additional offset is predefined or configured; and the pathloss estimation error is resulted from an inconsistency between a pathloss reference signal and an uplink beam.

In some embodiments, as illustrated in the FIG. 5, the apparatus further includes: a transmitting unit 503 configured to transmit, to the network device, an uplink transmission.

The above embodiments only illustrate the present disclosure. However, the present disclosure is not limited thereto, and appropriate variants may be made on the basis of the above embodiments. For example, the above embodiments may be used alone, or one or more of the above embodiments may be combined together.

It should be noted that the components or modules related to the present disclosure are only described above, however, the present disclosure is not limited thereto. The uplink transmission configuration apparatus 500 may also include other components or modules. Reference may be made to the related arts for specific content of these components or modules.

In addition, for the sake of simplicity, the FIG. 5 only exemplifies a connection relationship or a signal direction of components or modules, however, those skilled in the art should appreciate that the related arts such as bus connections may be adopted. The components or modules may be implemented by hardware facilities, such as a processor, a memory, a transmitter, and a receiver, which is not limited in the present disclosure.

As can be seen from the above embodiments, the terminal equipment receives configuration information from the network device, the configuration information being used to configure an AI/ML functionality/model and/or uplink power control, thus uplink power control information including a pathloss is able to be more accurately obtained, and therefore, accuracy and reliability of the uplink transmission are improved.

### Embodiments of a Fourth Aspect

Embodiments of the present disclosure provide an uplink transmission configuration apparatus which may be, for example, a network device, or may be one or more components or assemblies configured in the network device, and the same contents as those of the embodiments of the first to third aspects will not be described again.

FIG. 6 is another schematic diagram illustrating the uplink transmission configuration apparatus according to embodiments of the present disclosure. As illustrated in the FIG. 6, an uplink transmission configuration apparatus 600 includes: a transmitting unit 601 configured to transmit, to a terminal equipment, configuration information, the configuration information being used to configure an AI/ML functionality/model and/or uplink power control, the terminal equipment obtaining uplink power control information for uplink transmission according to the configuration information.

In some embodiments, as illustrated in the FIG. 6, the uplink transmission configuration apparatus 600 may further include: a receiving unit 602 configured to receive an uplink transmission transmitted by the terminal equipment.

The above embodiments only illustrate the present disclosure. However, the present disclosure is not limited thereto, and appropriate variants may be made on the basis of the above embodiments. For example, the above embodiments may be used alone, or one or more of the above embodiments may be combined together.

It should be noted that the components or modules related to the present disclosure are only described above, however, the present disclosure is not limited thereto. The uplink transmission configuration apparatus 600 may also include other components or modules. Reference may be made to the related arts for specific content of these components or modules.

In addition, for the sake of simplicity, the FIG. 6 only exemplifies a connection relationship or a signal direction of components or modules, however, those skilled in the art should appreciate that the related arts such as bus connections may be adopted. The components or modules may be implemented by hardware facilities, such as a processor, a memory, a transmitter, and a receiver, which is not limited in the present disclosure.

As can be seen from the above embodiments, the terminal equipment receives configuration information from the network device, the configuration information being used to configure an AI/ML functionality/model and/or uplink power control, thus uplink power control information including a pathloss is able to be more accurately obtained, and therefore, accuracy and reliability of the uplink transmission are improved.

### Embodiments of a Fifth Aspect

Embodiments of the present disclosure also provide a communication system. Reference may be made to the FIG. 1. The same contents as those of the embodiments of the first to fourth aspects will not be described again.

In some embodiments, a communication system 100 may at least include: a network device configured to transmit, to a terminal equipment, configuration information the configuration information being used to configure an AI/ML functionality/model and/or uplink power control; and the terminal equipment configured to obtain uplink power control information for uplink transmission according to the configuration information.

Embodiments of the present disclosure also provide a terminal equipment, however, the present disclosure is not limited thereto, and other devices may also be involved.

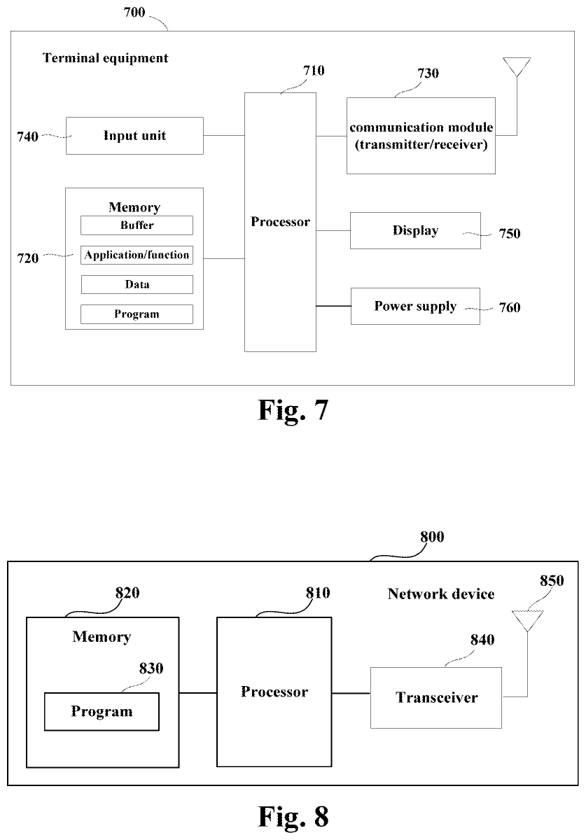

FIG. 7 is a schematic diagram illustrating a terminal equipment according to embodiments of the present disclosure. As illustrated in the FIG. 7, a terminal equipment 700 may include a processor 710 and a memory 720 that stores data and a program and is coupled to the processor 710. It should be noted that the figure is exemplary; and other types of structures may also be used to supplement or replace this structure, in order to implement telecommunication functions or other functions.

For example, the processor 710 may be configured to execute a program to implement the uplink transmission configuration method according to the embodiments of the first aspect. For example, the processor 710 may be configured to receive configuration information from a network device, the configuration information being used to configure an AI/ML functionality/model and/or uplink power control; and obtain uplink power control information for uplink transmission according to the configuration information.

As illustrated in the FIG. 7, the terminal equipment 700 may further include: a communication module 730, an input unit 740, a display 750, and a power supply 760, wherein functions of the above components are similar to those in the relevant art and will not be described herein again. It should be noted that the terminal equipment 700 does not necessarily include all the components illustrated in the FIG. 7, and the above components are not necessarily required. In addition, the terminal equipment 700 may also include components not illustrated in the FIG. 7. Reference may be made to the relevant art.

Embodiments of the present disclosure further provide a network device, which may be, for example, a base station, however, the present disclosure is not limited thereto, and other network devices may also be involved.

FIG. 8 is a schematic diagram illustrating a composition of a network device according to embodiments of the present disclosure. As illustrated in the FIG. 8, a network device 800 may include: a processor 810 (such as a central processing unit (CPU)) and a memory 820 coupled to the processor 810. The memory 820 may store various data. In addition, the memory 820 may store a program 830 for information processing, and the program 830 may be executed under the control of the processor 810.

For example, the processor 810 may be configured to execute a program to implement the uplink transmission configuration method according to the embodiments of the second aspect. For example, the processor 810 may be configured to transmit, to a terminal equipment, configuration information, the configuration information being used to configure an AI/ML functionality/model and/or uplink power control, the configuration information being used by the terminal equipment to obtain uplink power control information for uplink transmission.

In addition, as illustrated in the FIG. 8, the network device 800 may further include: a transceiver 840 and an antenna 850, wherein functions of the above components are similar to those of the relevant art and will not be described herein again. It should be noted that the network device 800 does not necessarily include all the components illustrated in the FIG. 8. In addition, the network device 800 may also include components not illustrated in the FIG. 8. Reference may be made to the relevant art.

Embodiments of the present disclosure also provide a computer program, wherein when the program is executed in a terminal equipment, the program enables the terminal equipment to perform the uplink transmission configuration method according to the embodiments of the first aspect.

Embodiments of the present disclosure also provide a storage medium storing a computer program, wherein the computer program enables a terminal equipment to perform the uplink transmission configuration method according to the embodiments of the first aspect.

Embodiments of the present disclosure also provide a computer program, wherein when the program is executed in a network device, the program enables the network device to perform the uplink transmission configuration method according to the embodiments of the second aspect.

Embodiments of the present disclosure also provide a storage medium storing a computer program, wherein the computer program enables a network device to perform the uplink transmission configuration method according to the embodiments of the second aspect.

The above apparatus and method of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a magnetic disk, a CD, a DVD, a flash memory, etc.

The method/apparatus described with reference to the embodiments of the present disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. These software modules may respectively correspond to the steps shown in the drawings. And these hardware modules, for example, may be carried out by firming these software modules by using a field programmable gate array (FPGA).

The software modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information to the memory medium; or the memory medium may be a component of the processor. The processor and the memory medium may be located in an ASIC. The software modules may be stored in a memory of a mobile terminal and may also be stored in a memory card of a pluggable mobile terminal. For example, if equipment (such as a mobile terminal) employs an MEGA-SIM card of a relatively large capacity or a flash memory device of a large capacity, the software modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in the present disclosure. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

The present disclosure is described above with reference to particular embodiments. However, it should be understood by those skilled in the art that such descriptions are illustrative only, and not intended to limit the protection scope of the present disclosure. Various variants and amendments to the present disclosure may be made by those skilled in the art according to the spirit and principle of the present disclosure, and such variants and amendments also fall within the scope of the present disclosure.

As to implementations containing the above embodiments, supplements are further disclosed below:
1. A method for configuring an uplink transmission, including:
receiving, by a terminal equipment, configuration information from a network device, the configuration information being used to configure an AI/ML functionality/model and/or uplink power control; and
obtaining, by the terminal equipment, uplink power control information for uplink transmission according to the configuration information.
2. A method for configuring an uplink transmission, including:
transmitting, by a network device, to a terminal equipment, configuration information, the configuration information being used to configure an AI/ML functionality/model and/or uplink power control, and the configuration information being used by the terminal equipment to obtain uplink power control information for uplink transmission.
3. A terminal equipment, including: a memory configured to store a computer program and a processor configured to execute the computer program to implement the method for configuring an uplink transmission according to supplement 1.
4. A network device, including: a memory configured to store a computer program and a processor configured to execute the computer program to implement the method for configuring an uplink transmission according to supplement 2.

1. An uplink transmission configuration apparatus, comprising:
a receiver configured to receive configuration information from a network device, the configuration information being used to configure an AI/ML functionality/model and/or uplink power control; and
processor circuitry configured to obtain uplink power control information for uplink transmission according to the configuration information.

2. The apparatus according to claim 1, wherein the processor circuitry is configured to estimate or predict the uplink power control information according to an AI/ML functionality/model.

3. The apparatus according to claim 2, wherein the uplink power control information comprises a pathloss, and the AI/ML functionality/model is used to predict reference signal received power of a pathloss reference signal to estimate a pathloss corresponding to the pathloss reference signal.

4. The apparatus according to claim 2, wherein one or more reference signals are used for measurement and a measured reference signal received power is input into the AI/ML functionality/model, and another one or more reference signals are used for output of the AI/ML functionality/model for inference.

5. The apparatus according to claim 2, wherein the AI/ML functionality/model is used to estimate or predict a pathloss of one or more beams in a spatial domain, and/or the AI/ML functionality/model is used to estimate or predict a pathloss of one or more beams in a temporal domain.

6. The apparatus according to claim 1, wherein an AI/ML functionality/model for uplink power control is the same as an AI/ML functionality/model for beam management, or an AI/ML functionality/model for uplink power control is different from an AI/ML functionality/model for beam management.

7. The apparatus according to claim 6, wherein a configured pathloss reference signal is used for input of the AI/ML functionality/model for uplink power control, and predicted reference signal received power or an estimated pathloss for a current beam is used for output of the AI/ML functionality/model for uplink power control.

8. The apparatus according to claim 6, wherein a reference signal in a second reference signal set for beam management is used for input of the AI/ML functionality/model for uplink power control, and predicted reference signal received power or an estimated pathloss for a configured pathloss reference signal is used for output of the AI/ML functionality/model for uplink power control.

9. The apparatus according to claim 6, wherein a reference signal in a second reference signal set for beam management is used for input of the AI/ML functionality/model for uplink power control, and a reference signal in a first reference signal set for beam management is used for output of the AI/ML functionality/model for uplink power control.

10. The apparatus according to claim 9, wherein predicted reference signal received power of a reference signal selected from the first reference signal set is used to estimate a pathloss.

11. The apparatus according to claim 1, wherein an AI/ML functionality/model for beam management is configured or enabled, and
one or more reference signals in a second reference signal set for beam management are configured as pathloss reference signals for uplink power control.

12. The apparatus according to claim 1, wherein an AI/ML functionality/model for beam management is configured or enabled, and
one or more reference signals in a first reference signal set for beam management are configured as pathloss reference signals for uplink power control.

13. The apparatus according to claim 1, wherein an AI/ML functionality/model for beam management is configured or enabled, and
one or more reference signals in a reference signal set for performance monitoring are configured as pathloss reference signals for uplink power control.

14. The apparatus according to claim 13, wherein the reference signal set for performance monitoring is the same as a first reference signal set for beam management, or the reference signal set for performance monitoring is different from a first reference signal set, or the reference signal set for performance monitoring at least partially overlaps with a first reference signal set, or the reference signal set for performance monitoring is a subset of a first reference signal set.

15. The apparatus according to claim 1, wherein an AI/ML functionality/model for beam management is configured or enabled, and
a reference signal of a current beam is used for performance monitoring and is configured as a pathloss reference signal for uplink power control.

16. The apparatus according to claim 1, wherein an AI/ML functionality/model for beam management is configured or enabled, and
a demodulation reference signal of a physical downlink control channel is configured as a pathloss reference signal for uplink power control.

17. The apparatus according to claim 1, wherein an AI/ML functionality/model for beam management is configured or enabled, and
a demodulation reference signal of a physical downlink shared channel is configured as a pathloss reference signal for uplink power control.

18. The apparatus according to claim 1, wherein an AI/ML functionality/model for beam management is configured or enabled,
for uplink power control, an additional offset is configured to compensate for a pathloss estimation error, the additional offset is predefined or configured, and the pathloss estimation error is resulted from an inconsistency between a pathloss reference signal and an uplink beam.

19. An uplink transmission configuration apparatus, comprising:
a transmitter configured to transmit, to a terminal equipment, configuration information, the configuration information being used to configure an AI/ML functionality/model and/or uplink power control, and the configuration information being used by the terminal equipment to obtain uplink power control information for uplink transmission.

20. A communication system, comprising:
a network device configured to transmit, to a terminal equipment, configuration information, the configuration information being used to configure an AI/ML functionality/model and/or uplink power control; and
the terminal equipment configured to obtain uplink power control information for uplink transmission according to the configuration information.
